(19) United States
(12) Patent Application Publication
(10) Pub. No.: US 2019/0034820 A1
(43) Pub. Date: Jan. 31, 2019

(54) METHOD, SYSTEM AND PROGRAM PRODUCT FOR FORECASTED INCIDENT RISK

(71) Applicants: Nathan Manning, Eltham (AU); Charles Warne, London (GB)

(72) Inventors: Nathan Manning, Eltham (AU); Charles Warne, London (GB)

(21) Appl. No.: 15/659,103

(22) Filed: Jul. 25, 2017

(51) Int. Cl. G06N 99/00; G06N 5/02; G06Q 50/26

(52) U.S. Cl. CPC G06N 99/005; G06Q 50/26; G06N 5/022

(57) ABSTRACT

A method, system and program product includes capturing at least a location of a user and communicating with a server system. The server system is operable for extracting crime incident data sets from data sources, processing the collected data, and generating forecasted incident risks for a plurality of geographical locations. A forecasted incident risk for the location is received. A notification for the user is generated. The notification at least includes a change in the forecasted incident risk for the location. A representation of the forecasted incident risk and the change in the forecasted incident risk is displayed.

### FEDERALLY SPONSORED RESEARCH OR DEVELOPMENT

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to a software data communication application. More particularly, certain embodiments of the invention relate to a software forecast application and system thereof.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is contemplated that “Big data” has become well known to the general public. It is believed that the use of big data may improve many lives of the general public. It may be further contemplated that the general public's access to big data may be limited, and information gleaned from big data may be difficult for the general public to understand and utilize effectively. For example, it is contemplated that in most, developed countries, crime rates may be decreasing. However, a Gallup poll conducted in 2010 demonstrated that American's may perceive crime as increasing even during a period of crime reduction with respect to the early 1990's. It may be contemplated that around two thirds of American's may believe that crime rates are increasing, and some Americans may believe a purported crime problem in the U.S. to be “extremely” or “very serious”. It is further contemplated that whilst some American's may feel that their neighbourhood crime rates may be increasing, they may fear that crime rates in other areas may be far worse. It is believed that this feeling of increasing and worsening crime likely reflects an additive fear from a lack of information regarding their surroundings as well as other areas. The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that conventional systems may typically provide location and probability based crime risk assessments for an individual located at a particular location.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1, illustrates an exemplary forecast application system architecture, in accordance with an embodiment of the present invention.

FIG. 2, illustrates an exemplary software module architecture of a forecast application system embodiment, in accordance with an embodiment of the present invention.

FIG. 3 illustrates a software module diagram of an embodiment of a forecast application system, in accordance with an embodiment of the present invention.

FIG. 4 illustrates a flowchart of an exemplary implementation embodiment of a forecast application system, in accordance with an embodiment of the present invention.

FIG. 5A, FIG. 5B, and FIG. 5C illustrate various exemplary displays provided by an exemplary implementation embodiment of a forecast application system, in accordance with an embodiment of the present invention, where FIG. 5A illustrates an exemplary notification, in accordance with embodiments of the present invention, FIG. 5B illustrates an exemplary radar chart, in accordance with an embodiment of the present invention, and FIG. 5C illustrates an exemplary heat map in accordance with an embodiment of the present invention.

FIG. 6 illustrates a flowchart of an exemplary implementation embodiment 600 of a forecast application system, in accordance with an embodiment of the present invention.

FIG. 7A and FIG. 7B illustrate various exemplary displays provided by an exemplary implementation embodiment of a forecast application system, in accordance with an embodiment of the present invention, where FIG. 7A illustrates an exemplary notification, in accordance with embodiments of the present invention, and FIG. 7B illustrates an exemplary map in accordance with an embodiment of the present invention.

FIG. 8 is a block diagram depicting an exemplary client/server system which may be used by an exemplary web-enabled/networked embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”, e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

### Terminology

The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviours can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

It may be contemplated that for big data to potentially have an optimal usability, it would be optimally accessed invisibly. Data analysis would optimally be relevant to a user's current situation in the context of their environment and community. Finally, it may be contemplated that data may be optimally visualized in a way that may both be relevant and instantly recognizable. Therefore, it may be contemplated that providing people with accurate information may give them requisite knowledge both to possibly reduce potential anxiety and to take action to possibly reduce real risk when required. Particularly, it may also be contemplated that individuals may be unaware of their exposure to risk of future possible incidences, and may further be unaware of their family and friend's risk, as well as the risks at their common locations such as, and without limitation, schools, libraries, places of work, parks, homes, etc. It may further be contemplated that individuals may be further unaware of potential risk that may be encountered on their journeys such as, and without limitation, journeys to/from at least the common places and uncommon places.

As will be described in some detail below with reference to the accompanying figures, many embodiments of the present invention may provide a software forecast application that may be configured to access big data, perform complex statistical analysis to contextualize that data and create estimations/predictions of potential future event occurrences for at least an individual. The software forecast application may further be configured to present that data in a manner that may be easily recognizable and actionable. Particularly, many embodiments of the present invention may provide a software forecast application that may be configured to create personal crime risk estimations/predictions for individuals, family/friends, current locations, and future locations based on for example, and without limitation, geospatial locations, historic crime data, statistical modelling, individuals' environment, individuals' activities, individuals' personal characteristics, a time of day, and/or a time of year, wherein the estimation/prediction may be delivered to an individual's computing devices such as, and without limitation, mobile devices, smartphones, tablets, laptops, desktops, etc. for user interaction. Many embodiments of the present invention may provide map based future crime risk displays including, but not limited to, providing information on proposed routes of travel, previous user movements, distant geographical locations and places of interest including, but not limited to, shopping centers, schools, offices etc. Many embodiments of the present invention may further provide the displaying of police or other law enforcement future crime risk data via map based displays. In many embodiments, estimations of future crime risk may be based on statistical modelling, aoristic temporal analysis, seasonality, risk terrain modelling, near repeats, collective efficacy and social media reports in combination with machine learning, for individuals, nominated family and friends, locations, and current or future travel. In some embodiments of the present invention, a forecast application system may provide crime risk estimation for personal use, family members, friends, location information, and intermediate travel location information. Furthermore, many embodiments may provide future crime risk estimation and notification of changes to future crime risk and changes to current crime risk.

Many embodiments of the present invention may provide estimations of future crime risk rather than reporting previous crime incidence, wherein future crime risk estimations may be provided to the individual, for tracked family/friends and for locations of the family/friends. In some embodiments, surveillance at times of perceived or actual security risks may also be provided. Furthermore, by tracking a user's routine movements, risk reports may be generated to inform the user of their risk exposure and potential options to reduce it. In addition, by tracking routine user activity, encounters with higher future crime risk environments may be anticipated and many embodiments may provide forewarning to the user or user contacts.

In many embodiments of the present invention, a forecast application system may be configured to provide estimations of forecasted risk to individuals, wherein the forecasted risk may include a calculated estimation/prediction of a future event occurrence and the risk may be related to, for example, and without limitation, crimes, weather, accidents, road closures, natural phenomena, such as, and without limitation fires, floods, tornadoes, storms, ocean tide changes, heat waves, air quality levels etc., unnatural phenomena, predetermined user desirable events, or any combination thereof. The forecast application system may further be configured to provide notifications of changes of forecasted risk. In some embodiments of the present invention, a forecast application system may be configured to provide estimations of forecasted risk and tracking of nominated parties, wherein nominated parties may be particularly identified trackable devices of individuals and/or objects, such as, and without limitation, family members, friends, associates, co-workers, teammates, human assets, pets, personal property, or any combination thereof. The forecast application system may further be configured to provide notifications of changes of forecasted risk for the particularly identified trackable devices of individuals and/or objects. In some embodiments of the present invention, a forecast application system may be configured to provide estimations of forecasted risk based on user nominated locations, wherein nominated locations may be for example, and without limitation, schools, libraries, work places, apartments, gyms, running pathways, homes, particular roads, parks, neighbourhoods, restaurants, malls, stores, stadiums, concerts, particular addresses, cities, states, countries, substantially any user desirable location suitable for the needs of a particular application, or any combination thereof. The forecast application system may further be configured to provide notifications of changes to the location based forecasted risk. In many embodiments of the present invention, a forecast application system may be configured to anticipate risk for planned travel and thus, may provide forecasted risk based on locations not yet visited by a user and/or nominated party. In many embodiments of the present invention a forecast application system may include a computing device, wherein forecast application software may be configured to activate audio/visual (AV) recording components of the device to record and document events. In many embodiments a computing device may be a mobile device, such as, and without limitation, a cellular phone, a tablet, a smartphone, a personal digital assistant (PDA), a laptop, vehicle dash camera, a wearable computing device, a smartwatch, a smart helmet, smart glasses, car or other vehicle navigation systems, portable audio systems, etc. In some other embodiments a computing device may be a non-mobile device such as a home/building security system, a desktop computer, and devices coupled to particular local wired/wireless networks such as gaming consoles, micro-consoles, digital media players such as, and without limitation, Amazon Echo™ and Apple TV™. In many embodiments, a computing device may be substantially any suitable device capable of interfacing via internet or any other communication networks to receive and execute computer-readable instructions. In some embodiments of the present invention, a forecast application system may be operably coupled to an unmanned aerial vehicle (UAV), wherein forecast application software may be configured to provide a request to the UAV for security surveillance or intervention.

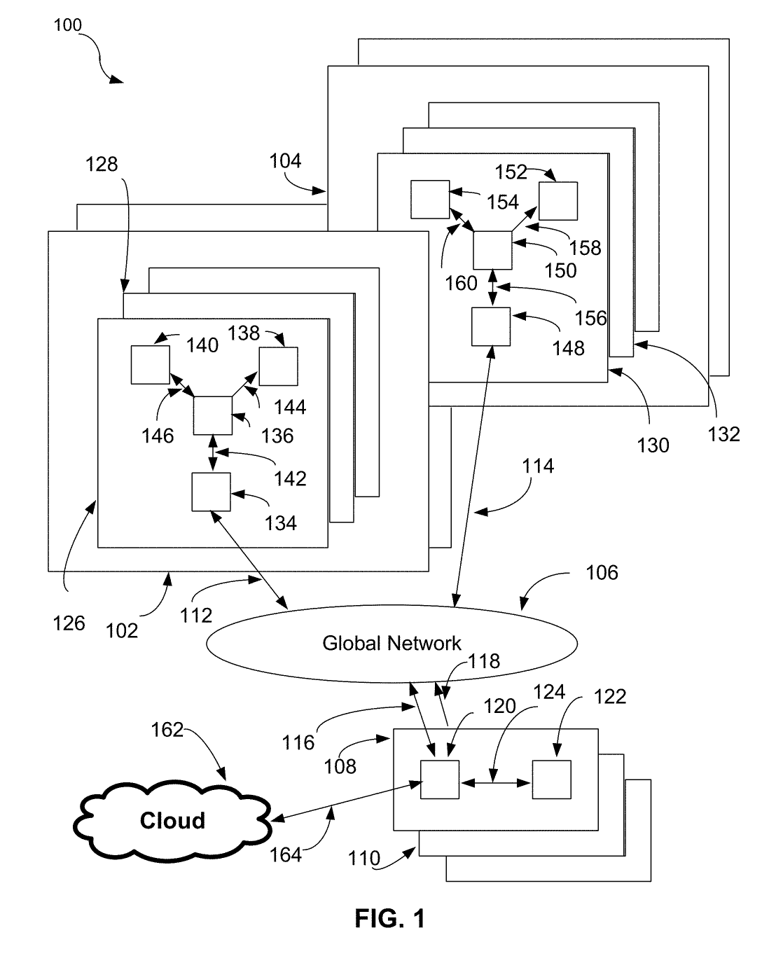

FIG. 1, illustrates an exemplary forecast application system architecture 100, in accordance with an embodiment of the present invention. In the present embodiment the forecast application system may include a multiplicity of networked regions with a sampling of regions denoted as a network region 102 and a network region 104, a global network 106 and a multiplicity of servers with a sampling of servers denoted as a server device 108 and a server device 110.

Network region 102 and network region 104 may operate to represent a network contained within a geographical area or region. Non-limiting examples of representations for the geographical areas for the networked regions may include postal zip codes, telephone area codes, states, counties, cities and countries. Elements within network region 102 and 104 may operate to communicate with external elements within other networked regions or within elements contained within the same network region.

In some implementations, global network 106 may operate as the Internet. It will be understood by those skilled in the art that the forecast application system may take many different forms. Non-limiting examples of forms for the forecast application system may include local area networks (LANs), wide area networks (WANs), wired telephone networks, cellular telephone networks, intranet, extranet, a virtual private network (vpn), non-tcp/ip based networks, or any other network supporting data communication between respective entities via hardwired or wireless communication networks. Global network 106 may operate to transfer information between the various networked elements.

Server device 108 and server device 110 may operate to execute software instructions, store information, support database operations and communicate with other networked elements. Non-limiting examples of software and scripting languages which may be executed on server device 108 and server device 110 include C™, C++, C#, Perl, PHP, Python, AppleScript, ColdFusion, Ruby, SQL, HTML, and Java. In the present embodiment, the server devices may further be programmed with statistical computing software such as, and without limitation, R-Studio, ADaMSoft, ADMB, DataMelt, DAP, GNU Octave, Matlab, ASP, OPENMx, Pandas-High performance computing, R-Programming with Big Data, Shogun (toolbox), Statistical Lab, or any other statistical computing software suitable for the needs of a particular application.

Network region 102 may operate to communicate bi-directionally with global network 106 via a communication channel 112. Network region 104 may operate to communicate bi-directionally with global network 106 via a communication channel 114. Server device 108 may operate to communicate bi-directionally with global network 106 via a communication channel 116. Server device 110 may operate to communicate bi-directionally with global network 106 via a communication channel 118. Network region 102 and 104, global network 106 and server devices 108 and 110 may operate to communicate with each other and with every other networked device located within communication system 100.

Server device 108 includes a networking device 120 and a server 122. Networking device 120 may operate to communicate bi-directionally with global network 106 via communication channel 116 and with server 122 via a communication channel 124. Server 122 may operate to execute software instructions and store readable information within a multiplicity of databases housed within server 122.

Network region 102 includes a multiplicity of clients with a sampling denoted as a client 126 and a client 128. Client 126 includes a networking device 134, a processor 136, a GUI 138 and an interface device 140. Non-limiting examples of devices for GUI 138 include monitors, televisions, a cellular phone, a tablet, a smartphone, a personal digital assistant (PDA), a laptop, vehicle dash camera, a wearable computing device, a smartwatch, a smart helmet, smart glasses, car or other vehicle navigation systems, portable audio systems, a home/building security system, a desktop computer, a gaming consoles, micro-consoles, digital media players, a work station, media streaming devices, brain-computer interface or substantially any suitable device capable of interfacing via internet or any other communication networks to receive and execute computer-readable instructions. Non-limiting examples of interface device 140 include pointing device, touch screen, speakers, mouse, trackball, scanner and printer. Networking device 134 may communicate bi-directionally with global network 106 via communication channel 112 and with processor 136 via a communication channel 142. GUI 138 may receive information from processor 136 via a communication channel 144 for presentation to a user for viewing. Interface device 140 may operate to send control information to processor 136 and to receive information from processor 136 via a communication channel 146. Network region 104 includes a multiplicity of clients with a sampling denoted as a client 130 and a client 132. Client 130 includes a networking device 148, a processor 150, a GUI 152 and an interface device 154. Non-limiting examples of devices for GUI 138 include monitors, televisions, a cellular phone, a tablet, a smartphone, a personal digital assistant (PDA), a laptop, vehicle dash camera, a wearable computing device, a smartwatch, a smart helmet, smart glasses, car or other vehicle navigation systems, portable audio systems, a home/building security system, a desktop computer, a gaming consoles, micro-consoles, digital media players a work station, media streaming devices, brain-computer interface, or substantially any suitable device capable of interfacing via internet or any other communication networks to receive and execute computer-readable instructions. Non-limiting examples of interface device 140 include pointing devices, touch screen, speakers, mouse, trackballs, scanners and printers. Networking device 148 may communicate bi-directionally with global network 106 via communication channel 114 and with processor 150 via a communication channel 156. GUI 152 may receive information from processor 150 via a communication channel 158 for presentation to a user for viewing. Interface device 154 may operate to send control information to processor 150 and to receive information from processor 150 via a communication channel 160.

For example, consider the case where a user interfacing with client 126 may want to execute a networked forecast application. A user may enter the IP (Internet Protocol) address for the networked forecast application using interface device 140. The IP address information may be communicated to processor 136 via communication channel 146. Processor 136 may then communicate the IP address information to networking device 134 via communication channel 142. Networking device 134 may then communicate the IP address information to global network 106 via communication channel 112. Global network 106 may then communicate the IP address information to networking device 120 of server device 108 via communication channel 116. Networking device 120 may then communicate the IP address information to server 122 via communication channel 124. Server 122 may receive the IP address information and after processing the IP address information may communicate return information to networking device 120 via communication channel 124. Networking device 120 may communicate the return information to global network 106 via communication channel 116. Global network 106 may communicate the return information to networking device 134 via communication channel 112. Networking device 134 may communicate the return information to processor 136 via communication channel 142. Processor 136 may communicate the return information to GUI 138 via communication channel 144. User may then view the return information on GUI 138.

Networking device 120 may also operate to communicate bi-directionally with a multiplicity of external data centers within a cloud storage network 162, wherein data from the multiplicity of data centers may be downloaded to the multiplicity of databases housed within server 108, via communication channel 164. In many embodiments of the present invention, the multiplicity of servers may belong to a cloud computing network.

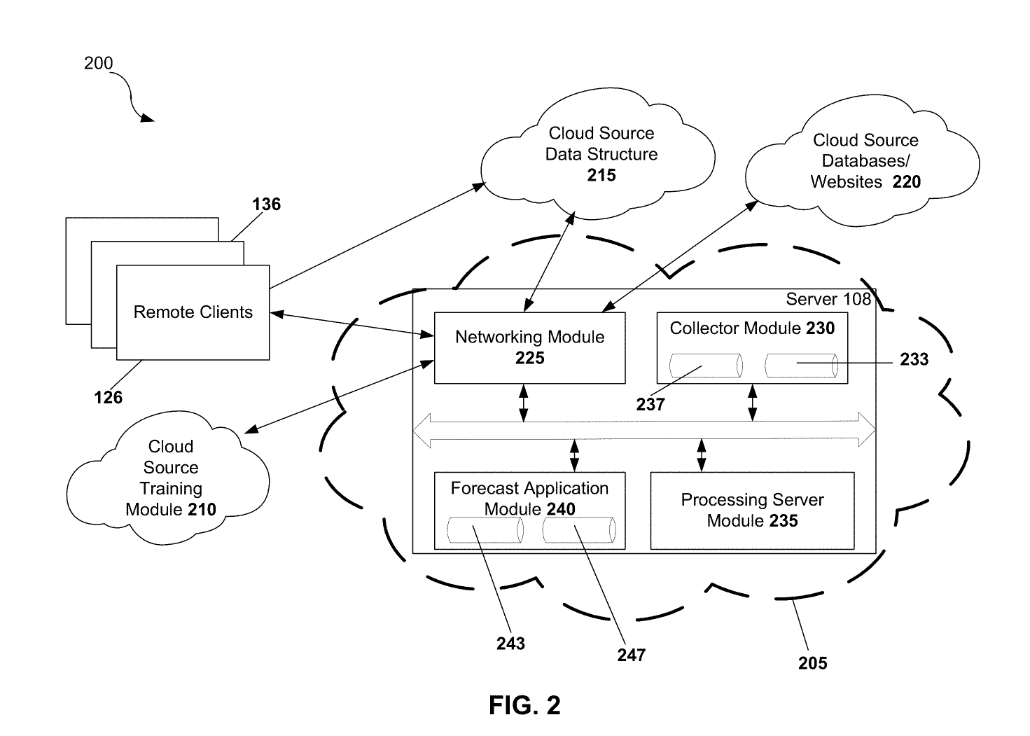

FIG. 2, illustrates an exemplary software module architecture 200 of a forecast application system embodiment, in accordance with an embodiment of the present invention. In many embodiments, and with reference to FIG. 1, the forecast application system may include server 108, wherein the server may belong to a cloud network 205, and may further be operably coupled to a cloud source training module 210, a cloud source data structure 215, cloud source databases and websites 220, and a multiplicity of remote clients, sampled here as remote clients 126 and 130. Server 108 may include at least a networking module 225, a collector module 230, a processing server module 235, and a forecast application module 240. Furthermore, collector module 230 may include at least a modelling parameter database 233 and a raw incident database 237. Moreover, the forecast application module may include at least a risk results database 243 and an event database 247. Server 108 may also include a data bus 250, wherein the networking module, the collector module, the processing server module, and the forecast application module may communicate and thus transfer data bi-directionally between each other via the data bus.

In many embodiments of the present invention, collector module 230 may be configured to include an application programming interface (API), wherein definitions and protocols of the collector module may be based on, for example, and without limitation, representation state transfer (REST) principles, simple object access protocols (SOAP), WebDAV, NFS, CIFS, iSCSI, CleverSafe™, Fast And Secure Protocol (FASP), FTP, Egnyte, Zetta, substantially any API protocol suitable for the needs of a particular application, or any combination thereof. Furthermore, in the present embodiment, collector module 230 may be configured to check for and extract cloud source and user source data from external sources via networking module 225, wherein the extracted data may be stored in modelling parameter database 233 or raw incident database 237, depending on the type of extracted data.

In many embodiments of the present invention, the collector module may perform daily checks and daily extraction of data from cloud source data structure 215, and also may perform daily checks and daily extraction of data from cloud source databases and websites 220, wherein data extracted from these sources may be stored in raw incident database 237. In some alternative embodiments the checks and/or extractions may be performed continuously, minute by minute, hourly, or at substantially any time interval suitable for the needs of a particular application. In many embodiments the cloud source databases and websites may be for example, and without limitation, open data sources of incidences provided by local government and/or law enforcement agencies. In some alternative embodiments the cloud source databases and websites may be open data sources and/or private data sources provided by for example, and without limitation, state government agencies, national government agencies, third party data brokers, local and foreign news agencies, research centers, foreign government agencies, or any combination thereof. In some embodiments of the present invention, the cloud source data structure may include open data sources, wherein users may report incidences. Furthermore, the cloud source data structure may also include reports from non-users via social media sites, such as, and without limitation, twitter, Facebook, Myspace, blogs, substantially any other suitable media site for the needs of a particular application, or any combination thereof. In many embodiments, the raw incident database may house a multiplicity of incident data sets, wherein each incident data set may include for example, and without limitation, a date, time, geographical location (latitude/longitude and/or x/y coordinates), incident type, and outcome for each one of a multiplicity of incidents over a particular period of time. In some alternative embodiments, incident data sets may further include, particular details about the incident, such as, and without limitation, a number of individuals involved, physical characteristics of individuals involved, activities of individuals involved, weather and environmental conditions, a season etc. Optimally, the particular period of time over which the model parameters will be estimated may be approximately 3 years, however the particular time period may be substantially any time period suitable for the needs of a particular application. Furthermore, the raw incident database may be configured to house each incident data set on a different line of the raw incident database, and new incidences, and thus corresponding incident data sets, may be added daily or at substantially any time interval suitable for the needs of a particular application.

Moreover, in many embodiments, the collector module may also periodically check for and periodically extract parameter data from cloud source training module 210, wherein parameter data extracted from the cloud source training module may be stored in modelling parameter database 233. In many embodiments, the cloud source training module may be a remote cloud computing source, wherein the parameter data may be trained using a modelling of incident data. In many embodiments, the remote cloud computing source may be an internet-based computing system such as, and without limitation, Elastic Compute Cloud™, Microsoft AZURE™, OpenStack™, Oracle Cloud, or substantially any other open or private cloud computing providing service that may provide Infrastructure as a Service (IaaS), Platform as a Service (PaaS), and/or Software as a Service (SaaS) functionalities or Amazon™ AWS. Furthermore, the cloud source training module may include modelling risk based on for example, and without limitation, geographical locations and incident types, wherein the incident types may be modelled for particular regions. Moreover, an availability of particular incident types may depend on what incident data may be currently available to the remote cloud computing source. In an alternative embodiment the risk modelling may further be based on one or more of, for example and without limitation, geographical locations, incident types, a time of a day, a day of a week, a week of a month, a month of a year, an activity of involved individuals, a weather condition, a season, a social gathering event, a monetary worth of involved individuals, debilities and other physical characteristics of involved individuals, proximity to transportation either private or public, concurrent sporting events or major community events, news or social media reports of crimes by both professionals and members of the public or any combination thereof. In many embodiments, of the present invention, the risk modelling may further include modelling using a self-exciting marked point process model with parameters estimated via an Expectation-Maximization (EM) algorithm, wherein a ‘marked’ point process may be used to allow for a possibility that some incident types may affect the risk of others. By way of example, and without limitation, instead of only using past homicides to predict future homicide, any other crime types that may be found to predict homicide may also be included in the modelling (such as weapons violations, assault, robbery, etc), thereby potentially improving predictive power by utilizing more relevant crime data available. In some embodiments, the modelling may include for example, and without limitation, aoristic temporal analysis, seasonality, risk terrain modelling, near repeats, collective efficacy and social media reports, geographical location information, and/or particular incident data, wherein the analysis may be refined by machine learning. In many embodiments, the modelling may incorporate a forecasted risk based on an historical rate of an incident in a given year or other relatively long term periods. The modelling may also incorporate a forecasted risk based on a relatively recent rate of an incident over a past few weeks/months or other relatively short term period. It may be contemplated that by analysing and modelling data with respect to relatively long term historic time periods and relatively short term recent time periods, a predictive accuracy may be more optimal compared to more traditional models that may only incorporate one of these components. Particularly, a model may be trained for each incident type for a particular cell of a geospatial grid until EM algorithm parameter estimates converge, and a total intensity of an incident occurrence in each cell of an appropriately scaled geospatial grid (i.e. 250 meter×250 meter cells) may be calculated. Each grid cell may be ranked into quintiles of forecasted incident risk or any number of appropriate scales. As new incident data may arrive, the forecasted incident risk rankings for each cell may be updated using the converged parameter estimates, until new parameter estimates may be modelled. The converged parameter estimates may be retrained on a less frequent basis depending on their stability over time. In many embodiments, the modelling parameter database may house a multiplicity of trained model parameters based on a dynamic statistical modelling, wherein model training may be performed in the cloud source training module. Optimally, parameters may be updated approximately every 3 months, however, parameters may be updated at substantially any time period suitable for the needs of a particular application. In many embodiments, the collector module may also be configured to transfer data from the raw incident database and/or the modelling parameter database to processing server module 235, via data bus 250, for processing. It may be appreciated, by one of ordinary skill in the art, that the crime data may be imported from other sources other than a cloud source.

In many embodiments of the present invention, processing server module 235 may be configured to include statistical computing software such as, and without limitation, R-Studio. In some alternative embodiments, utilized statistical computing software may include, for example, and without limitation, ADaMSoft, ADMB, DataMelt, DAP, GNU Octave, Matlab, ASP, OPENMx, Pandas-High performance computing, R-Programming with Big Data, Shogun (toolbox), Statistical Lab, Stata, SAS or substantially any other statistical computing software suitable for the needs of a particular application, or a combination thereof, wherein the processing server module may receive data from the collector module and execute computer-readable instructions to perform a statistical analysis of the received data. In many embodiments of the present invention, the statistical analysis may include utilizing the incident data sets and the parameter data to generate a multiplicity of result data sets, wherein the multiplicity of result data sets may further include calculated forecasted incident risks per geographical location. Furthermore, particular geographical locations may be grouped into geographical grid zones, wherein a forecasted incident risk may be calculated for each zone using at least a combination of each calculated forecasted incident risk per geographical location. In many embodiments, the modelling may use not only data on crime incidence but also on the interaction of the incidence of various crimes upon one another In many embodiments, as new incidences may occur, and thus may be extracted by collector module 230, the processing server may receive a latest version of incident data sets and may further refresh the multiplicity of result data sets based on the new incidences. Moreover, in many embodiments, the processing server module may also be configured to process the incident data sets to generate a cleaned version of the incident data sets. As data may come from any number of sources, with respect to the physical location of the data, the type of data collected by a particular source and the manner by which it is collected and stored, data may be considered to be heterogeneous with respect to both content and format. Therefore some form of rearranging and reformatting may be necessary to allow the data to be used by the statistical model. In many embodiments, the processing server module may be configured to transfer generated data sets to risk results database 243 and event database 247 of the forecast application module, via data bus 250, wherein the multiplicity of result data sets may be transferred to and stored in the risk results database, and the generated cleaned incident data sets may be transferred to and stored in the event database.

In many embodiments of the present invention, forecast application module 240 may be configured to include API protocols such as, and without limitation, Hypertext Transfer (HTTP), Extensible Markup Language (XML), JavaScript Object Notation (JSON), SOAP, service-oriented architecture, REST, resource oriented architecture (ROA), Resource Description Framework (RDF), substantially any other well-known protocols suitable for the needs of the particular application, or any combination thereof, wherein the forecast application module may receive generated data from the processing server module. In many embodiments, the forecast application module may be configured download executable computer-readable instructions for forecast application execution, data sets of the event database, and data sets of the risk results database to requesting client devices, wherein processors and GUIs of the requesting client device may execute the executable computer-readable instructions to display and allow the forecast application to be accessed, launched, and used by a user of the client device.

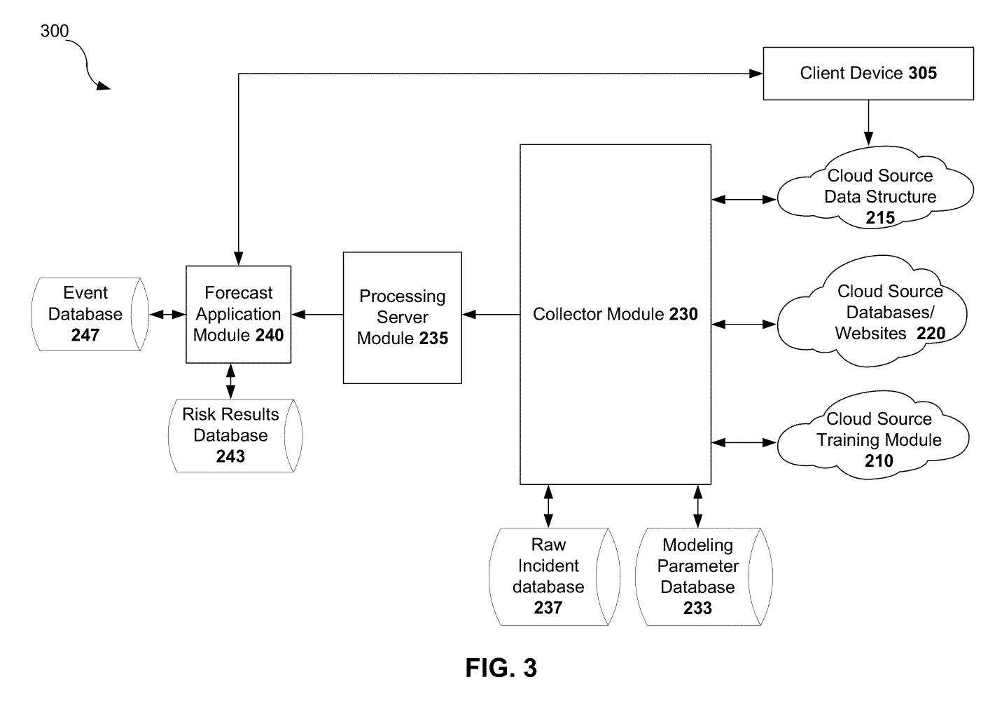

FIG. 3 illustrates a software module diagram 300, of an embodiment of a forecast application system, in accordance with an embodiment of the present invention. Crime data is held only on the server with future crime risk data calculated and stored on the server. The present embodiment may interact with the server and pull down the relevant crime risk data for the user's location, proposed route or typical route or members of the user's family or other predefined contacts. One server may provide data for multiple locations, however, with respect to data transfer speeds some locations may be better served by having local servers. In the present embodiment, and with reference to FIG. 1 and FIG. 2, collector module 230 may be configured to operate to check for and extract data sets from cloud source data structure 215, cloud source databases and/or websites 220, and/or the cloud source training module 210, via the networking module (not shown here). The extracted data sets may comprise incident data sets related to a multiplicity of locations around the world or particular subsets of worldly locations, and/or trained parameter data, wherein the incident data sets may be stored in raw incident database 237, and the trained parameter data may be stored in modelling parameter database 233. Furthermore, processing server module 235 may be operably configured to utilize the incident data sets and the parameter data to generate a multiplicity of result data sets, wherein the multiplicity of result data sets may further include calculated forecasted incident risks per geographical location. Also the processing server module may also be operably configured to process the incident data sets to generate a cleaned version of the incident data sets. In many embodiments, the multiplicity of result data sets may be transferred to and stored in risk results database 243, and the generated cleaned incident data sets may be transferred to and stored in event database 247. Moreover, forecast application module 240, may be operably configured to receive and process purchase and download request of a forecast application from a client device 305, wherein the forecast application may further be operably configured to download stored data sets and executable computer-readable instructions, for forecast application execution, to the client device. In some alternative embodiments, the collector module and/or the processing server module, may operate as configured before a potential user may download and use a forecast application. In some other alternative embodiments the collector module and/or the processing server module may operate as configured after a potential user may download and/or use a forecast application. In the present embodiment, the client device may be an exemplary, and without limitation, mobile device, wherein the mobile device may provide the user with a graphical interactive interface to view and interact with forecast application software executed by processors of the mobile device. In many embodiments, stored data and software may be made available from the forecast application module, to mobile devices such as, and without limitation, cellular phones, tablets, smartphones, personal digital assistants (PDA), laptops, vehicle dash cameras, a wearable computing devices, a smartwatches, smart helmets, smart glasses, car or other vehicle navigation systems, portable audio systems, or substantially any suitable portable devices capable of interfacing via internet or any other communication networks to receive and execute computer-readable instructions. In some other embodiment the client device may be an exemplary, and without limitation fixed device, such as, and without limitation, a home/building security system, a desktop computer, a gaming consoles, micro-consoles, digital media players, a work station, media streaming devices, or substantially any suitable device capable of interfacing via internet or any other communication networks to receive and execute computer-readable instructions. In many embodiments, access and use of the forecast application may be provided on a subscription basis. In the present embodiment, after downloading and launching forecast application software on a user's device, the launched forecast application may capture the user's location. The User's location would be tracked constantly or as near to as possible to begin providing the user with notifications of forecasted possible incident risks and changes to the forecasted possible incident risk based on a present location. The server may communicate with the forecast application on the user's device to update the forecasted possible incident risk based on a user possibly changing geographic location, a change in forecasted possible incident risk in the current location, or anticipated travel to an area with an altered forecasted possible incident risk. The application would communicate with the server and by extension the user may have access to the server, however, the raw data would not be available to the user. In the present embodiment, forecast application module 240, may receive a location inquiry from the launched forecast application, wherein the forecast application module may perform a database look-up using a location of the location inquiry to locate location corresponding risk results data sets and location corresponding cleaned incident data sets. The forecast application module may then transmit the located data sets back to the launched forecast application for use related to one or more forecasted risk displays. In the present embodiment, the launched forecast application may be configured to display a ‘heat map’ on the user's mobile device, wherein the heat map may illustrate forecasted incident risk scores and/or rankings of grid cells superimposed over a map for a given location. In some embodiments, the heat map may include layer data such that a user may also be able to zoom in to see where individual incidences may have occurred during a given period of time. The layered data may also allow users to be able to view which particular incidences may be influencing forecasted risk. In many embodiments the forecast application module may be configured to receive GPS locations of users, nominated parties of users, and/or user nominated locations, wherein nominated parties may include, for example, and without limitation, family members, friends, associates, co-workers, teammates, human assets, pets, personal property, or any combination thereof, and nominated locations may include, for example, and without limitation, schools, libraries, work places, gyms, running pathways, homes, particular roads, parks, neighborhoods, restaurants, malls, stores, stadiums, concerts, particular addresses, cities, states, countries, substantially any desirable user designated location, or any combination thereof. The forecast application module may be operably configured to perform a database look-up using the GPS locations of users, nominated parties, and/or nominated locations to locate location corresponding risk results data sets and location corresponding cleaned incident data sets. The forecast application module may then transmit the located data sets back to the users and/or nominated parties for use related to the one or more forecasted risk displays. In the present embodiment, the downloaded forecast application may also be configured to display incident risk alerts, wherein an incident risk alert may include a viewable indication of a forecasted risk change and/or status of one or more users, one or more nominated parties, and/or one or more nominated locations. In many embodiments, an exemplary user and one or more exemplary nominated party members may be in different locations respectively, and thus the forecast application module may simultaneously monitor incident risk over multiple locations. In some embodiments, there may be no direct access to the server for users

In many embodiments of the present invention, a forecast application system may be operably configured to provide a multiplicity of functions, wherein the multiplicity of functions may include, for example, and without limitation, personal risk estimation, nominated party and/or nominated location risk estimation, anticipated risk estimation, and incident reporting, which will be described below, by way of exemplary, and without limitation, reference to crime. However, those skilled in the art would readily recognize in light of and in accordance with the teaching of the present invention that the incident data, training, and forecasted incident risk may be related to particular incident types such as, and without limitation, weather, accidents, road closures, natural phenomena, such as, and without limitation fires, floods, tornadoes, storms, ocean tide changes, heat waves, air quality levels, meteor showers and other predictable astronomical events, etc., unnatural phenomena, such as, and without limitation, stock market fluctuations, sporting event outcomes, election outcomes, etc., and predetermined user desirable events, or any combination thereof, wherein the forecast application system may be configured to be communicatively coupled to particular cloud source data centers which may contain and provide particular data sets related to the particular incident types.

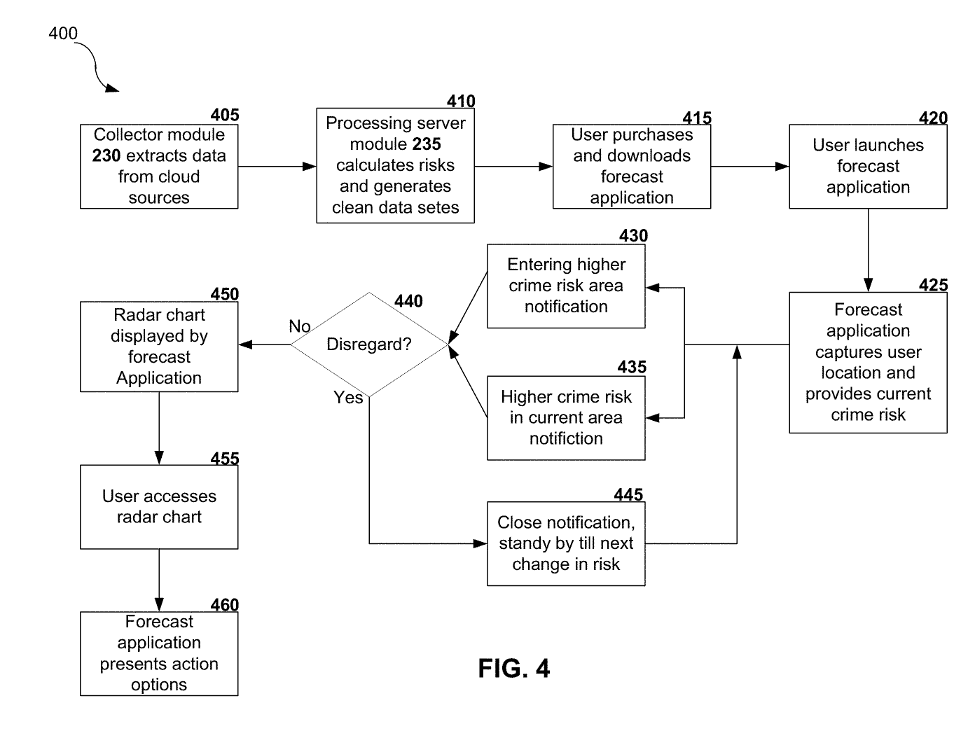

FIG. 4 illustrates a flowchart of an exemplary implementation embodiment 400 of a forecast application system, in accordance with an embodiment of the present invention. In the present embodiment a forecast application may provide an estimate of a forecasted incident risk to a user based on a user's current location, wherein the forecasted incident risk may be a forecasted crime risk. In a step 405, collector module 230 may extract crime incident data sets from cloud source data structure 215, and cloud source databases and/or websites 220, wherein the crime incident data sets extracted from these sources may include for example, and without limitation, a multiplicity of crime types, particular crime incidences, locations of those crime incidences, times and dates of those crime incidences, outcomes, a number of individuals involved, physical characteristics of individuals involved, activities being performed by involved individuals, and substantially any other possibly noted details concerning the crime or individuals involved. Furthermore, crime types may include, for example, and without limitation, robbery, burglary, assault, homicide, theft, kidnapping, rape, armed robbery, grand theft auto, larceny, identity theft, cyber violent crimes, petty crimes, armed crimes, etc. The collector module may also extract parameter data from cloud source training module 210, wherein the parameter data may include trained crime parameters. In the present embodiment, training performed in the cloud source training module may include modelling crime risk based on for example, and without limitation, geographical locations of particular crime incidences, and crime incident types. In a step 410, processing server module 235 may receive and utilize the crime incident data sets and the trained crime parameters to calculate a multiplicity of forecasted crime risks with respect to a multiplicity of geographical locations respectively, wherein each of the forecasted crime risk may indicate a crime score for a corresponding geographical location. The processing server module may also generate a clean version of the crime incident data sets and transfer the multiplicity of forecasted crime risks and clean version of the crime incident data sets to forecast application module 240. In a step 415, a user may purchase a subscription to access the forecast application system, wherein the forecast application module may download processor executable forecast application software and stored data sets of the forecast application module databases to a user's device. Next, in a step 420, a forecast application may be launched on the user's device by processors of the user's device executing the processor executable forecast application software. In a step 425, the launched forecast application may capture a user's location and provide a viewable and/or audible personal forecasted crime risk notification via the user's device, wherein the personal forecasted crime risk notification may include a crime score corresponding to a current location of the user. In a case that a personal crime risk may increase, the increase may be due to a change in the user's location to a higher ranked area or new data indicating a new occurrence related to the current area In many embodiments, crime risk may be calculated on an ongoing basis as new data becomes available rather. In some embodiments, crime risk may be modified by, but not limited to, time of day as well as changing weather conditions, public holidays, sporting or other community events. In some embodiments, the new data may be for example, and without limitation, a new crime incident, or a new time/date related to a higher risk of a crime incident occurring, and/or other new conditions that may be associated with higher risk that may now be in effect. In some embodiments, the forecast application may capture a plurality of locations input by the user for a planned travel. In a case that a personal crime risk may increase due to a user location change, in a step 430, the forecast application may display and/or sound a notification on the user's device that the user may be entering a higher crime risk area. In a case that a personal crime risk may increase due to a new data occurrence, in a step 435, the forecast application may display and/or sound a notification on the user's device that a crime risk may have increased in a current location. In either case of increased crime risk notification, the user may choose to open the forecast application or disregard the notification in a decision step 440. In a case that the user may disregard the notification, the user may close the notification and the forecast application may wait, in a step 445, until another change in personal crime risk may occur to display and/or sound another notification. In a case that the user may open the forecast application in response to the notification, in a step 450, the forecast application may display a radar chart indicating crimes that may be most likely to occur in the user's present location. The user may then access the radar chart in a step 455, wherein the forecast application, may present for example, and without limitation, a total crime risk, individual crimes, there specific locations and their relative contribution to the total crime risk, a plot of the user's previous crime risk for visual comparison, and/or crime risk likelihoods of particular zones via the radar chart. In some alternative embodiments, the forecast application may present suggestions to decrease the personal crime risk, wherein the suggestion may include, for example, and without limitation, notifications of areas a user may want to move to. In a step 460, the forecast application may then present action options, wherein the action options may include, for example and without limitation, directions out (via google maps or other suitable navigation programs), a heat map which may illustrate crime risks of surrounding areas, directions to a subway or other public transportation, notifications to call Uber or other cabbing services, call home, call 911 or the number of emergency services, call a contact listed on a user's device, report a possible crime, activate audio/visual recording of the user's device, and/or activate a UAV for possible intervention. In some alternative embodiments, the user may be notified of current incidents occurring near their location. In some alternative embodiments, a user may submit current user activities such as, and without limitation, driving a car, riding a bike, jogging, walking, camping, shopping, performing a bank transaction, etc., wherein parameter data may be trained and incident data sets may include using possible user activities and thus the indicated user activity may affect a personal crime risk of the user. Furthermore, in another alternative embodiment, the user may indicate particular crime types to be weighted more during statistical analysis.

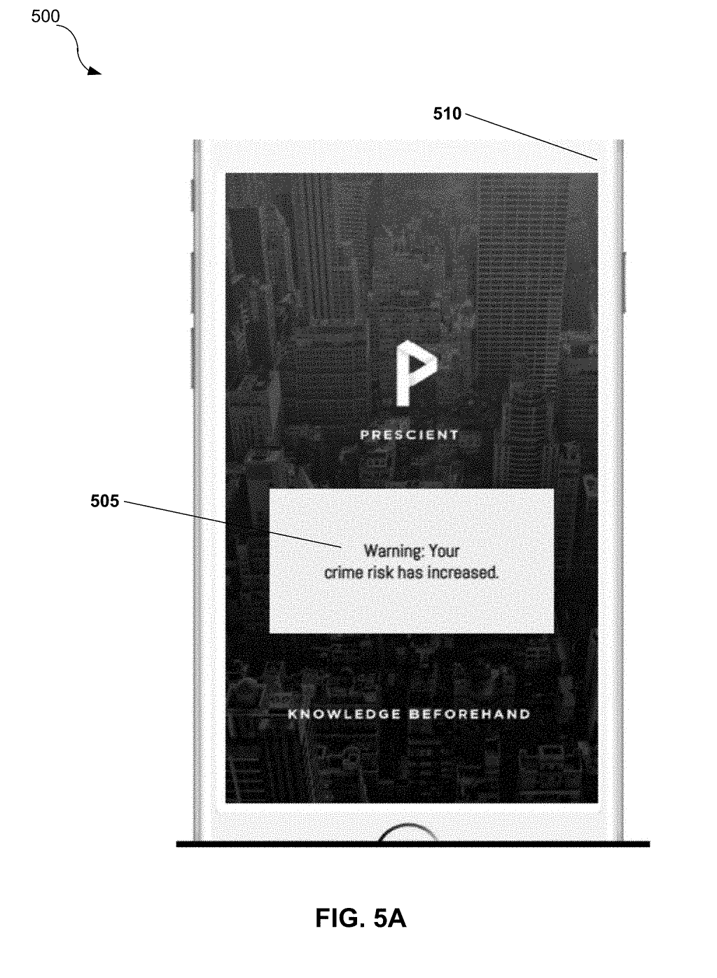

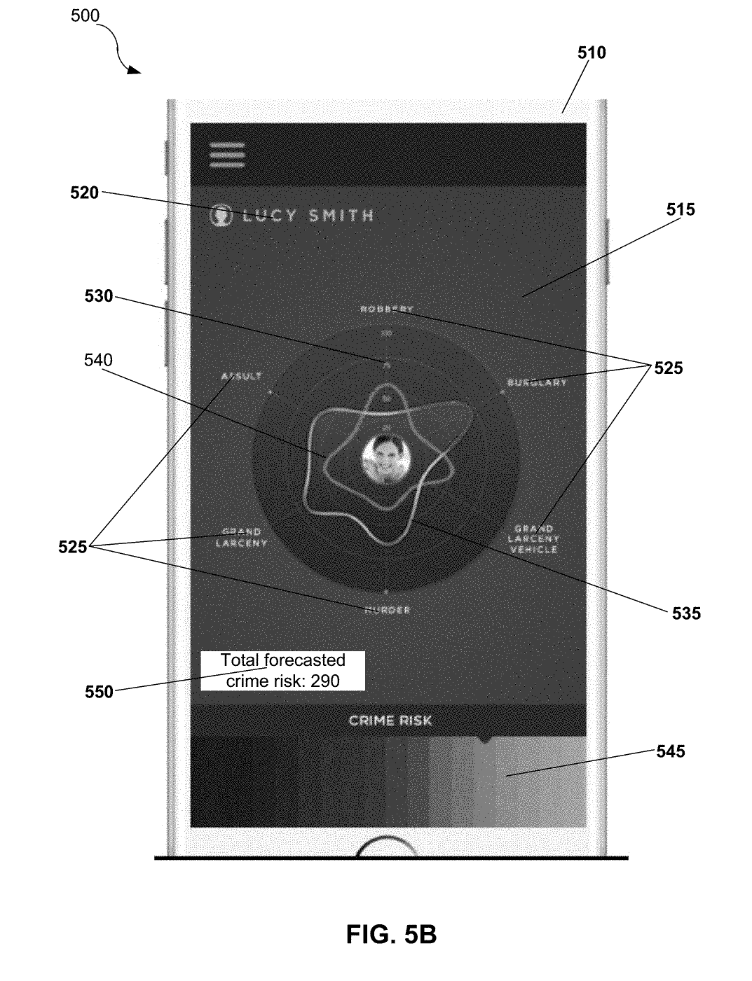

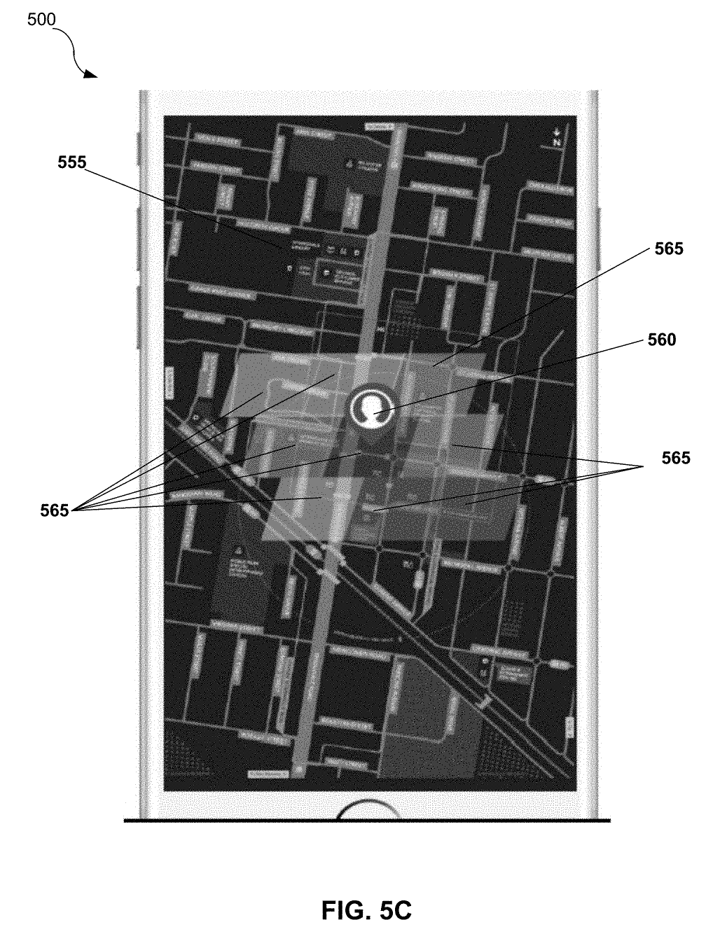

FIG. 5A, FIG. 5B, and FIG. 5C illustrate exemplary displays 500 provided by an exemplary implementation embodiment of a forecast application system, in accordance with an embodiment of the present invention, where FIG. 5A illustrates an exemplary notification, in accordance with embodiments of the present invention, FIG. 5B illustrates an exemplary radar chart, in accordance with an embodiment of the present invention, and FIG. 5C illustrates an exemplary heat map in accordance with an embodiment of the present invention. In many embodiments, and with reference to FIG. 4, a forecast application system may provide one or more of a notification 505 to a user's device 510, wherein the notification may be in response to a change in crime risk as described above with respect to steps 430 and 435. Furthermore, FIG. 5B illustrates an exemplary radar chart, in accordance with an embodiment of the present invention in many embodiments of the present invention. a radar chart 515 may be displayed on the user's device 510, wherein the radar chart may include an identifier 520, a multiplicity of crime types 525, a scaled radar chart 530, a plot of a one or more current crime risk scores 535, a plot of one or more previous crime risk scores 540, and a gradient intensity scale 545. In some alternative embodiments the radar chart may also include a total crime risk score 550, wherein the total crime risk score may include a summation of individual crime risk scores corresponding to individual crime types. In many embodiments the identifier may display a name of a user which the radar chart may be related to. In some other embodiments the identifier may display a name of a nominated party or a name of a nominated location, wherein data displayed by the radar chart may be with respect to the nominated party or nominated location. In many embodiments, the multiplicity of crime types may include crime types that have available reported data that may be extracted from the cloud data sources. In some alternative embodiments the multiplicity of crime types may include user designated crime types, wherein the forecast application system may check for and extract crime incident datasets and parameter data sets related to the designated crime types for use by the forecast application. In many embodiments, the scaled radar chart may include a lined and marked graph, marked to indicate a multiplicity of scale amounts, wherein the graph may be circular, rectangular, or substantially any other shape suitable for the needs of a particular application. Furthermore, in many embodiments, the plot of one or more current crime risk scores may include data points for each displayed crime type, wherein the data point may be plotted on top of the scaled radar chart such that a value of the data points may be observed. The plot may include a line graph, bar graph, histogram, pie charts, and/or substantially any other type of plot suitable for the needs of a particular application. In many embodiments the plot of one or more current crime risk scores may be color coded, wherein a color of data points may correspond to a level/intensity of a crime risk score. In some embodiments, a plot of one or more previous crime risk scores may also be plotted on top of the scaled radar chart but behind the plot of one or more current crime risk scores such that a comparison of current vs previous crime risk scores may be observed. In some alternative embodiments, a current crime risk plot and a previous crime risk plot may illustrate crime risk scores of different crime type respectively. For example, and without limitation, a previous plot may illustrate crime risk scores of homicide, assault, and armed robbery, while a current plot may illustrate crime risk scores of burglary, larceny, and robbery. In some alternative embodiments, some crime types may be the same and some crime types may differ between a current and previous plot. In many embodiments, illustrated crime types may be the same between a current and previous plot. In another alternative embodiment, the radar chart may display a plurality of previous plots behind a current plot. In many embodiments, the total crime risk score may be a forecasted crime risk, based on individual crime risk scores of each crime type, wherein the total crime risk score may include a summation of the individual crime risk scores. Furthermore, the gradient intensity scale may be a color coded scale, wherein the colors corresponds to intensity/severity levels of the total crime risk score. In many embodiments, the gradient intensity scale may include a pointer which may point to a color that corresponds to an intensity/severity level of the total crime risk score. Also, in many embodiments of the present invention, the forecast application may display a heat map on the user's device. FIG. 5C illustrates an exemplary heat map, in accordance with an embodiment of the present invention, wherein the heat map may include a geographical map 555 of local surroundings, a current location of a user 560, and a multiplicity of color coded regions 565 superimposed on the geographical map. The color coded regions may represent regions of varying forecasted crime risk, wherein the colors may correspond to a multiplicity of crime score levels respectively. A user may utilize the map to travel from, avoid, or travel to, a desired location. In some other embodiments a heat map may include a current location of a nominated party and/or nominated location, wherein regions of varying forecasted risk may be calculated and illustrated with respect to a location of the nominated party and/or nominated location.

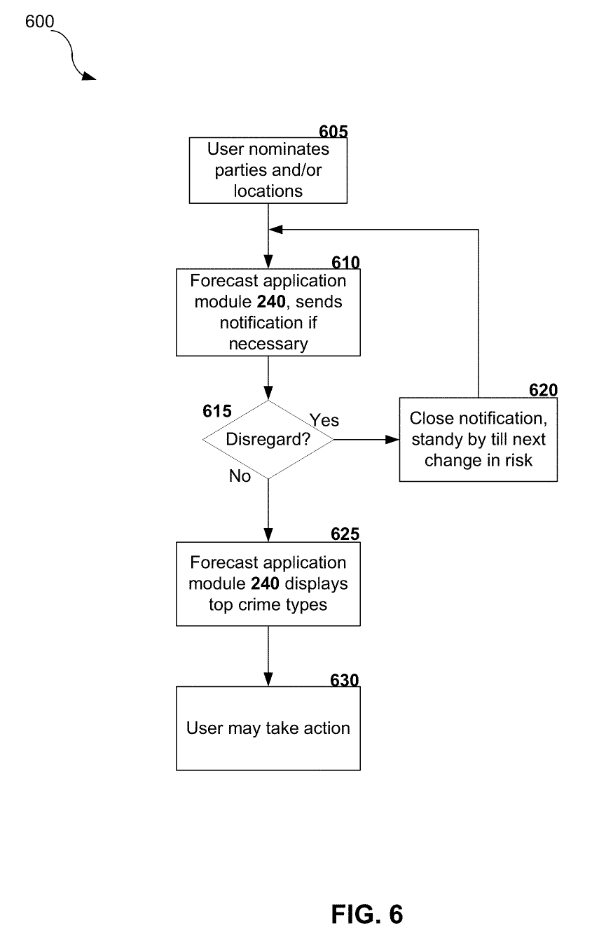

FIG. 6 illustrates a flowchart of an exemplary implementation embodiment 600 of a forecast application system, in accordance with an embodiment of the present invention. In the present embodiment, a forecast application may provide an estimate of a forecasted incident risk to a user with respect to a nominated party and/or nominated location, wherein the forecasted incident risk may be a forecasted crime risk. After a user may purchase and download a forecast application, the user may operate the forecast application to nominate particular parties and/or particular locations, in a step 605, which may also be monitored by the forecast application system. In some embodiments, particular location nomination may be performed by the user submitting GPS locations of the particular locations, wherein the forecast application module may receive the GPS locations and return stored data sets for use by the user downloaded forecast application. In some embodiments, one or more particular party nominations may be performed by the user submitting contact information of the one or more nominated parties, and the one or more nominated parties may purchase a subscription, download forecast application software, and use a forecast application as described in FIG. 4. Furthermore, in a case that a forecasted crime risk may increase for one or more nominated parties and/or one or more nominated locations, the user may receive a notification, in a step 610, via the forecast application module, indicating that a forecasted crime risk in a region of a nominated party/location may have increased. The user may choose to open the forecast application or disregard the notification in a decision step 615. In a case that the user may disregard the notification, the user may close the notification and the forecast application may wait, in a step 620, until another change in personal and/or nominated party/location crime risk may occur to display and/or sound another notification. In a case that the user may open the forecast application in response to the notification, in a step 625, the forecast application may display a predetermined number of top crime types for the area, wherein the predetermined number may optimally be five, however, substantially any number of crime types may be displayed depending on the needs suitable for particular applications. In a step 630, the user may take action by messaging a nominated party via the forecast application and/or activating home and/or vehicle security systems, lights, surveillance etc., via the forecast application, in addition to possible actions described with reference to FIG. 5. In some embodiments, the user may be notified in a case that one or more nominated parties leaves and/or enters particular regions. In some alternative embodiments, in a case that a forecasted crime risk may decrease for the one or more nominate parties/locations, the user may receive a notification indicating that the forecasted crime risk has decreased in the region of the nominated party/location. In some alternate embodiments, the user may receive notification that a nominated party/location is involved in a current incident. In some alternate embodiments, the user may receive details of the current incident. In some alternate embodiments, the user may request a UAV for surveillance of the current incident. In some alternative embodiments, the user may request a video feed from the UAV.

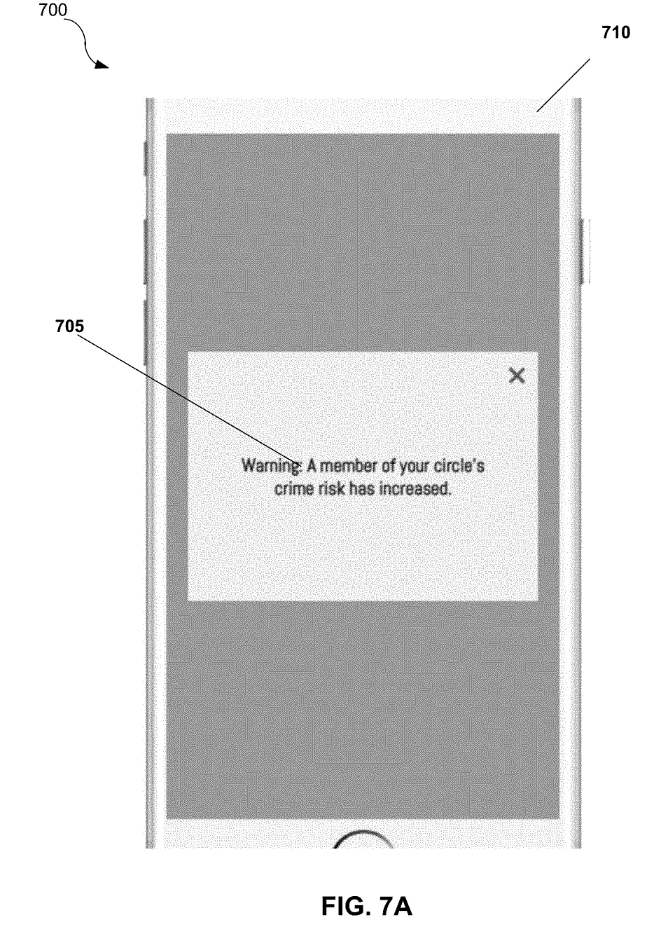

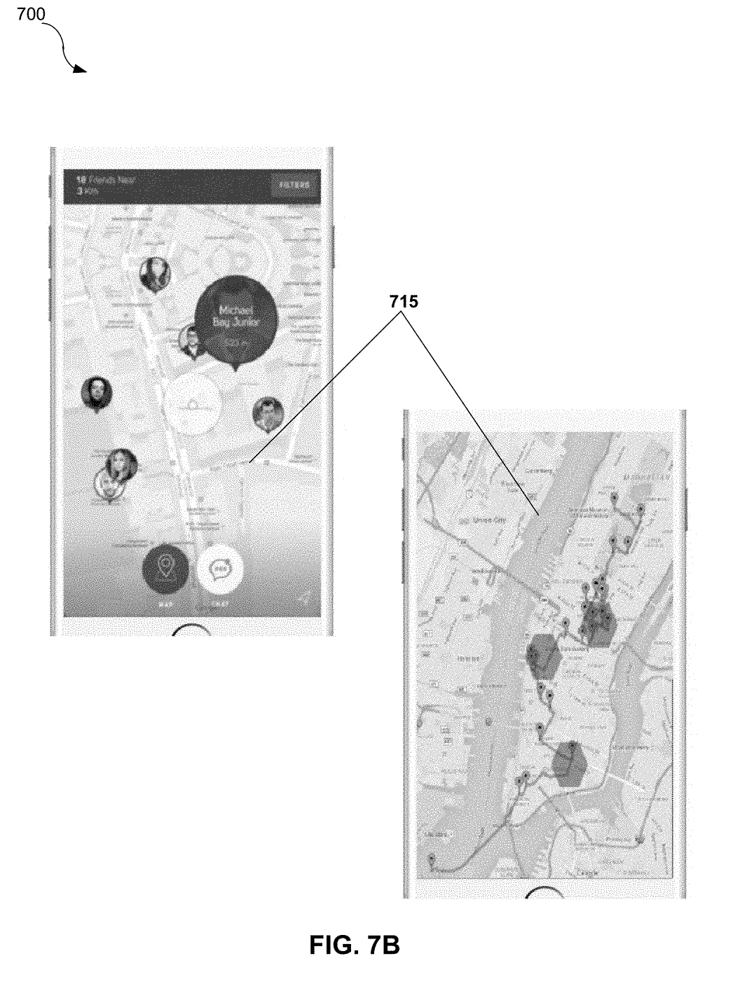

FIG. 7A and FIG. 7B illustrate exemplary displays 700 provided by an exemplary implementation embodiment of a forecast application system, in accordance with an embodiment of the present invention, where FIG. 7A illustrates an exemplary notification, in accordance with embodiments of the present invention and FIG. 7B illustrates an exemplary map in accordance with an embodiment of the present invention. In many embodiments, and with reference to FIG. 6 and FIG. 7A a forecast application system may provide one or more of notification 705 to a user's device 710, wherein the notification may be in response to a change in forecasted crime risk as described above with respect to step 610. Also, in many embodiments of the present invention, the forecast application may display a map on the user's device. FIG. 7B illustrates an exemplary map in accordance with an embodiment of the present invention, wherein a multiplicity of nominated parties and/or nominated locations may be superimposed and identified on map 715. In some alternative embodiments a multiplicity of color coded regions may also be superimposed on map 715, wherein the color coded regions may represent regions of varying forecasted crime risk, and the colors may corresponds to a multiplicity of crime score levels respectively.

In many embodiments of the present invention a forecast application may continuously or periodically capture a GPS location of a device which the forecast application may be installed upon and thus the forecast application may provide a tracking of user movements. Furthermore, the forecast application may store GPS locations and generate routine travel patterns by establishing a series of GPS location. In some embodiments the forecast application module may provide notifications and/or route maps illustrating forecasted crime risk to a user's device, wherein the notification and/or route maps may be based on forecasted crime risk scores related to the series of GPS locations. Furthermore, users and nominated party users may be notified if they may be likely to encounter increased crime risk along a route, wherein the users and nominated party users may send interventions services to each other. Intervention services may include for example, and without limitation, a cabbing services, activation of remote users' audio/visual recording components of the remote users' devices, police agencies, a UAV, sending alternate routes, activation of an alarm or ring tone of remote users' devices, or any combination thereof. In some alternative embodiments, a user and/or nominated party user may submit GPS locations of future travel plans, wherein the forecast application module may provide notifications and/or route maps illustrating forecasted crime risk to the user's device and/or nominated user's device based on the GPS location of the future travel plans. In some other alternative embodiments, a user and/or nominated party user may submit planned activities and conditions such as, and without limitation, driving, walking, jogging, biking, swimming, going shopping, going to work going to school, going to an outdoor entertainment event, clubbing, a time of day, a day of week, weather, personal debilities, monetary worth, or any combination thereof, to a forecast application, wherein a forecast application module may utilize the activities and/or conditions to generate new forecasted crime risks.

In many embodiments of the present invention, a forecast application may store user locations with respect to forecasted crime risk such that the user of that forecast application may generate and review reports of their forecasted crime risk exposure over a preceding week, month, year, or substantially any other time period suitable for the needs of a particular application. This may allow users to view their exposure to forecasted crime risk throughout everyday life and thus providing users with information to possibly reduce their crime risk exposure. The reports may include particular crime incidence and trends in the user's area.

In many embodiments of the present invention, a forecast application module may be cooperatively integrated with mapping and travel application software such as, and without limitation, Google maps, Apple maps, TOMTOM™, Garmin or substantially any other mapping provider that may provide application programming interfaces (API)s for application integration by utilizing particular JavaScript software development kits (SDK)s, API keys, corresponding APIs, and at least a geospatial plug-in wherein particular executable computer-readable instructions may further be included in the integration to produce map marker indicating forecasted crime risk for local travel including alternative routes. In some embodiments, additional integration may also be provided with transportation application software such as, and without limitation Uber™ and Lyft™, so that users may request transportation out of a current location via a forecast application. Also in some embodiments, home security and maintenance products such as, and without limitation, Nest, Canary, or substantially any other home security provider that may provide application programming interfaces (API)s for application integration may be incorporated to both anticipate the users' arrival or departure in addition to other integrated functions via the forecast application.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

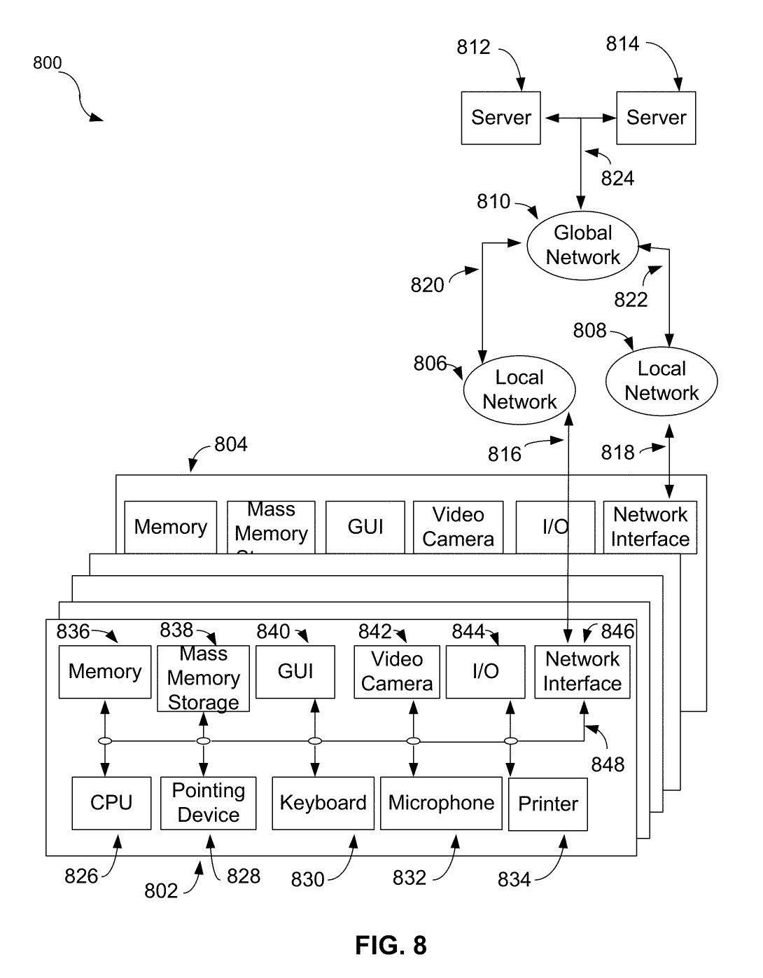

FIG. 8 is a block diagram depicting an exemplary client/server system which may be used by an exemplary web-enabled/networked embodiment of the present invention.

A communication system 800 includes a multiplicity of clients with a sampling of clients denoted as a client 802 and a client 804, a multiplicity of local networks with a sampling of networks denoted as a local network 806 and a local network 808, a global network 810 and a multiplicity of servers with a sampling of servers denoted as a server 812 and a server 814.

Client 802 may communicate bi-directionally with local network 806 via a communication channel 816. Client 804 may communicate bi-directionally with local network 808 via a communication channel 818. Local network 806 may communicate bi-directionally with global network 810 via a communication channel 820. Local network 808 may communicate bi-directionally with global network 810 via a communication channel 822. Global network 810 may communicate bi-directionally with server 812 and server 814 via a communication channel 824. Server 812 and server 814 may communicate bi-directionally with each other via communication channel 824. Furthermore, clients 802, 804, local networks 806, 808, global network 810 and servers 812, 814 may each communicate bi-directionally with each other.

In one embodiment, global network 810 may operate as the Internet. It will be understood by those skilled in the art that communication system 800 may take many different forms. Non-limiting examples of forms for communication system 800 include local area networks (LANs), wide area networks (WANs), wired telephone networks, wireless networks, or any other network supporting data communication between respective entities.

Clients 802 and 804 may take many different forms. Non-limiting examples of clients 802 and 804 include personal computers, cellular phones, tablets, smartphones, personal digital assistants (PDA), laptops, vehicle dash cameras, a wearable computing devices, a smartwatches, smart helmets, smart glasses, car or other vehicle navigation systems, portable audio systems, or substantially any suitable portable devices capable of interfacing via internet or any other communication networks to receive and execute computer-readable instructions.

Client 802 includes a CPU 826, a pointing device 828, a keyboard 830, a microphone 832, a printer 834, a memory 836, a mass memory storage 838, a GUI 840, a video camera 842, an input/output interface 844 and a network interface 846.

CPU 826, pointing device 828, keyboard 830, microphone 832, printer 834, memory 836, mass memory storage 838, GUI 840, video camera 842, input/output interface 844 and network interface 846 may communicate in a unidirectional manner or a bi-directional manner with each other via a communication channel 848. Communication channel 848 may be configured as a single communication channel or a multiplicity of communication channels.

CPU 826 may be comprised of a single processor or multiple processors. CPU 826 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 836 is used typically to transfer data and instructions to CPU 826 in a bi-directional manner. Memory 836, as discussed previously, may include any suitable computer-readable media, intended for data storage, such as those described above excluding any wired or wireless transmissions unless specifically noted. Mass memory storage 838 may also be coupled bi-directionally to CPU 826 and provides additional data storage capacity and may include any of the computer-readable media described above. Mass memory storage 838 may be used to store programs, data and the like and is typically a secondary storage medium such as a hard disk. It will be appreciated that the information retained within mass memory storage 838, may, in appropriate cases, be incorporated in standard fashion as part of memory 836 as virtual memory.

CPU 826 may be coupled to GUI 840. GUI 840 enables a user to view the operation of computer operating system and software. CPU 826 may be coupled to pointing device 828. Non-limiting examples of pointing device 828 include computer mouse, trackball and touchpad. Pointing device 828 enables a user with the capability to maneuver a computer cursor about the viewing area of GUI 840 and select areas or features in the viewing area of GUI 840. CPU 826 may be coupled to keyboard 830. Keyboard 830 enables a user with the capability to input alphanumeric textual information to CPU 826. CPU 826 may be coupled to microphone 832. Microphone 832 enables audio produced by a user to be recorded, processed and communicated by CPU 826. CPU 826 may be connected to printer 834. Printer 834 enables a user with the capability to print information to a sheet of paper. CPU 826 may be connected to video camera 842. Video camera 842 enables video produced or captured by user to be recorded, processed and communicated by CPU 826.

CPU 826 may also be coupled to input/output interface 844 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 826 optionally may be coupled to network interface 846 which enables communication with an external device such as a database or a computer or telecommunications or internet network using an external connection shown generally as communication channel 816, which may be implemented as a hardwired or wireless communications link using suitable conventional technologies. With such a connection, CPU 826 might receive information from the network, or might output information to a network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC § 112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6). In some embodiments, the methods and/or system components which may be located and/or performed remotely include, without limitation: data sources, and interaction with 3^{rd} party products.

It is noted that according to USA law, all claims must be set forth as a coherent, cooperating set of limitations that work in functional combination to achieve a useful result as a whole. Accordingly, for any claim having functional limitations interpreted under 35 USC § 112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC § 112 (6) is/(are) dependent on one or more remote servers located outside the USA, it is intended that each such recited function under 35 USC § 112 (6) is to be interpreted as the function of the local system receiving the remotely generated information required by a locally implemented claim limitation, wherein the structures and or steps which enable, and breath life into the expression of such functions claimed under 35 USC § 112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC § 112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a software forecast application system according to the present invention will be apparent to those skilled in the art. Various aspects of the invention have been described above by way of illustration, and the specific embodiments disclosed are not intended to limit the invention to the particular forms disclosed. The particular implementation of the software forecast application system may vary depending upon the particular context or application. By way of example, and not limitation, the software forecast application system described in the foregoing were principally directed to a software application that may be operated on a user's device to provide the user with event predictions based on at least a user's location, wherein events may be particularly related to crime implementations; however, similar techniques may instead be applied to providing weather, sporting, astrological, political, stock market, relationship compatibility, and epidemiology event predictions, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A method comprising the steps of:
capturing at least a location of a user;
communicating with a server system, the server system at least being operable for extracting crime incident data sets from data sources, processing the collected data, and generating forecasted incident risks for a plurality of geographical locations;
receiving a forecasted incident risk for the location;
generating a notification for the user, the notification at least comprising a change in the forecasted incident risk for the location; and
displaying a representation of at least the forecasted incident risk and the change in the forecasted incident risk.

2. The method as recited in claim 1, in which said capturing further captures an additional location of a nominated party of the user and said generating further generates a notification of a change in a forecasted incident risk for the additional location.

3. The method as recited in claim 1, in which said capturing further captures an additional location of a nominated party designated by the user and said generating further generates a notification of a change in a forecasted incident risk for the additional location.

4. The method as recited in claim 1, in which said capturing further captures an additional location of a nominated location designated by the user and said generating further generates a notification of a change in a forecasted incident risk for the additional location.

5. The method as recited in claim 1, in which said capturing further captures additional locations for a travel by the user and said receiving further receives forecasted incident risks for the additional locations.

6. The method as recited in claim 1, further comprising the step of presenting action options to the user.

7. The method as recited in claim 6, in which the action options comprises activating recording equipment.

8. The method as recited in claim 6, in which the action options comprises requesting an unmanned aerial vehicle.

9. A system comprising:
a forecast application being at least operable for executing on a client computing device to receive user inputs and display notifications and data to the user;
a collector module being at least operable for extracting crime incident data sets from data sources;
a training module being at least configured for training crime parameter data using a modelling of incident data;
a processing module being at least configured for receiving the crime incident data sets and the trained crime parameter data to calculate a multiplicity of forecasted crime risks with respect to a multiplicity of geographical locations respectively; and
a forecast application module being at least configured for communicating with said forecast application to send instructions and data sets, the data sets at least comprising a forecast crime risk for a geographical location associated with the user, wherein said forecast application generates a notification for the user, the notification at least comprising a change in the forecasted incident risk for the location, said forecast application further displays a representation of at least the forecasted incident risk and the change in the forecasted incident risk.

10. The system as recited in claim 9, in which said forecast application displays action options to the user, the action options at least comprising activating recording equipment and requesting an unmanned aerial vehicle.

11. A non-transitory computer-readable storage medium with an executable program stored thereon, wherein the program instructs one or more processors to perform the following steps:
capturing at least a location of a user;
communicating with a server system, the server system at least being operable for extracting crime incident data sets from data sources, processing the collected data, and generating forecasted incident risks for a plurality of geographical locations;
receiving a forecasted incident risk for the location;
generating a notification for the user, the notification at least comprising a change in the forecasted incident risk for the location; and
displaying a representation of at least the forecasted incident risk and the change in the forecasted incident risk.

12. The program instructing the one or more processors as recited in claim 11, in which said capturing further captures an additional location of a nominated party of the user and said generating further generates a notification of a change in a forecasted incident risk for the additional location.

13. The program instructing the one or more processors as recited in claim 11, in which said capturing further captures an additional location of a nominated party designated by the user and said generating further generates a notification of a change in a forecasted incident risk for the additional location.

14. The program instructing the one or more processors as recited in claim 11, in which said capturing further captures an additional location of a nominated location designated by the user and said generating further generates a notification of a change in a forecasted incident risk for the additional location.

15. The program instructing the one or more processors as recited in claim 11, in which said capturing further captures additional locations for a travel by the user and said receiving further receives forecasted incident risks for the additional locations.

16. The program instructing the one or more processors as recited in claim 11, further comprising the step of presenting action options to the user.

17. The program instructing the one or more processors as recited in claim 16, in which the action options comprises activating recording equipment.

18. The program instructing the one or more processors as recited in claim 16, in which the action options comprises requesting an unmanned aerial vehicle.

19. The program instructing the one or more processors as recited in claim 11, further comprising the step of presenting action options to the user, the action options at least comprising activating recording equipment and requesting an unmanned aerial vehicle, in which said capturing further captures an additional location of a nominated party of the user and said generating further generates a notification of a change in a forecasted incident risk for the additional location, said capturing further captures an additional location of a nominated party designated by the user and said generating further generates a notification of a change in a forecasted incident risk for the additional location, said capturing further captures an additional location of a nominated location designated by the user and said generating further generates a notification of a change in a forecasted incident risk for the additional location, said capturing further captures additional locations for a travel by the user and said receiving further receives forecasted incident risks for the additional locations.

20. A method comprising:
steps for capturing a location of a user;
steps for communicating with a server system, the server system at least being operable for generating forecasted incident risks for a plurality of geographical locations;
steps for receiving a forecasted incident risk for the location;
steps for generating a notification for the user;
steps for displaying a representation of at least the forecasted incident risk and a change in the forecasted incident risk; and
steps for presenting action options to the user.
